(19) United States
(12) Patent Application Publication
(10) Pub. No.: US 2011/0285983 A1
(43) Pub. Date: Nov. 24, 2011

(54) METHOD FOR THE OPTICAL MEASUREMENT OF VELOCITIES AND A SENSOR FOR THE OPTICAL MEASUREMENT OF VELOCITIES

(75) Inventors: Arno Bergmann, Gelsenkirchen (DE); Siegfried Wienecke, Dortmund (DE); Christian Jakschies, Bergisch Gladbach (DE)

(73) Assignee: Fraba AG, Koln (DE)

(21) Appl. No.: 12/672,756

(22) PCT Filed: Jul. 10, 2008
(86) PCT No.: PCT/EP2008/059004

§ 371 Date: Jan. 26, 2011

(30) Foreign Application Priority Data
Aug. 10, 2007 (DE) 10 2007 038013.7

(51) Int. Cl. G01P 3/36

(52) U.S. Cl. 356/28

(57) ABSTRACT

A method for measuring a velocity of an object surface relative to a sensor having a plurality of light-sensitive elements arranged spaced apart from one another. Each light-sensitive element produces an element signal indicative of detected brightness. The method includes receiving element signals at intervals of time, producing a frequency signal according to a spatial frequency filter method, producing a correlation signal according to an image processing method, and monitoring the produced frequency signal regarding at least one of a frequency value and at least one quality feature of the frequency signal. The method also includes selecting a produced signal for determining the velocity of the object surface relative to the sensor, and selecting the correlation signal in the event that at least one of the frequency signal lies below a threshold frequency value and the frequency signal fails to achieve a threshold quality feature value.

The disclosure relates to a method for the measurement of a velocity of an object surface relative to a sensor, wherein the sensor has a plurality of light-sensitive elements arranged spaced apart from one another, from which read-outs are taken at intervals of time. The disclosure furthermore relates to a sensor for the measurement of a velocity of an object surface relative to the sensor.

For the measurement of relative velocities between an observer and/or sensor and the surface of an object there are sensors of known art that operate in accordance with various methods. In general in the measurement of relative velocities between the sensor and a surface it is immaterial whether the sensor moves relative to the object, or the object moves relative to the sensor. Ultimately the velocity measurement is based on the determination of a length, for example the path covered by the object in the measuring field of the sensor within a particular time. From the measured displacement and the time required the velocity can thus be determined. By a simple integration over the measured time the path covered and/or the length of an object can also be determined with an appropriate sensor. Sensors for contactless measurement of a relative velocity are also therefore suitable for the measurement of length.

A plurality of methods are possible for the contactless measurement of a relative velocity. One of these methods is the spatial frequency filter method. Typically an object surface is radiated with light and the back-scattered light is measured by a light-sensitive detector through an optical grating. As a result of the movement of the object surface bright-dark fluctuations arise in the optical grating, the frequency of which is proportional to the velocity of the object surface. In the spatial frequency filter method the object surface is divided into patterned regions corresponding to the optical grating and their brightness is evaluated. Compared, for example, with the laser-Doppler method, the structural complexity of a sensor for the spatial frequency filter method is relatively low. However, the spatial frequency filter method delivers relatively large measurement errors in the field of low object velocities, since the determination of the velocity is based on a frequency measurement of a signal that is usually noisy. Particularly problematical here is the fact that if the object to be measured is stationary, this leads to a frequency of “0” that cannot be detected by the spatial frequency filter method.

A further option for measuring a displacement of an object surface relative to a sensor is presented by the image processing method. In this method images of the object surface are taken in the form of lines or areas over a particular interval of time and compared with one another. In the context of such a comparison, for example, individual images can be displaced relative to one another in terms of pixels, forming in each case a difference image. If with a particular displacement vector the result is a virtual cancellation of the images, this displacement vector represents the object displacement. In another embodiment of the image processing method the correlation function between two images taken at a certain interval in time is calculated, from the characteristic behaviour of which the displacement of the object surface in the interval in time in which the images were taken, can be determined in a manner known per se. In a further alternative embodiment of the image processing method precise object features are located in each image and by comparison with images taken at another point in time their displacement and thus the object displacement are determined.

The advantage of the imaging processing method is based on the fact that even at very low object velocities, or if the object is stationary, correct velocity values can be determined. However, the image processing method is always linked with a high level of computing effort. Furthermore the resolution that can be achieved is less than with the spatial frequency filter method, or with the laser-Doppler method.

In one aspect, the disclosure provides a method for the measurement of a velocity of an object surface relative to a sensor, which enables precise measurements over a wide range of velocities, in particular even at low velocities, and which at the same time is distinguished in terms of a limited technical complexity and computing effort.

In some implementations, a method for the measurement of a velocity of an object surface relative to a sensor takes place in accordance with the spatial frequency filter method and the image processing method, the frequency signal determined in the spatial frequency filter method is monitored with regard to the frequency value determined and/or with regard to at least one quality feature, and in the event that the frequency signal lies below a frequency value to be established, and/or the frequency signal does not achieve a quality feature value to be established, the value determined in the image processing method is used to determine the relative velocity.

A particular advantage of the method includes its universal applicability for precise contactless velocity measurements both of objects that are moving quickly and also objects that are moving slowly, or at times are even stationary. For each velocity range a decision is made on the basis of criteria that can be prescribed by the user, namely a limiting frequency proportional to a velocity limit, or by other signal quality features, by means of selection provided in the sensor, as to which method is selected in each case to determine the velocity. Thus the precise spatial frequency filter method, associated with low measurement errors and a comparatively low level of computing effort, is always used to determine the velocity of the object surface if the frequency signal lies above a frequency value prescribed by the user, and/or if signal quality features prescribed by the user are achieved. In the other case, i.e. with very low velocities for which the known disadvantages of the spatial frequency filter method increasingly come into play, the image processing method is selected by the means of selection for the measurement of velocity.

In some implementations, the quality features of the frequency signal obtained in the spatial frequency filter method can be its half-width, and/or the signal-noise ratio, and/or the spurious free dynamic range (SFDR). Signal quality features of this kind can be simply recorded in computing terms and represent a significant decision criterion. On the one hand it is possible simply to draw on the frequency limit to be prescribed, or one of the quality features cited, as a decision criterion. Similarly it is possible to draw on a selection of a plurality of quality features with or without taking into account the frequency value proportional to the relative velocity.

In some implementations, the value determined for purposes of determining the relative velocity in the image processing method, which, as already elucidated, comes into use if the frequency signal of the spatial frequency filter method does not satisfy the prescribed quality criteria, and/or lies below a prescribed frequency limit, is monitored with regard to at least one quality feature, and in the event that the value determined does not achieve a quality feature value to be established, the measurement is discarded. Alternatively instead of discarding the measurement the value determined for the determination of the relative velocity can be replaced by the valid value lastly determined in a previous measurement process or by an average value of a plurality of lastly determined valid values, in particular by their arithmetic mean or by their median. In particular in the case of objects that are moving evenly only a small error is thereby caused by virtue of the continuity. In the case of objects that are moving dynamically it can in turn be sensible to replace the value determined for the determination of the relative velocity by an extrapolation of the characteristic of the lastly determined valid values.

The image processing method can be implemented in a different manner in computing terms. Thus it is, for example, possible to determine the value determined in the image processing method for purposes of determining the relative velocity by locating features of the object surface and determining the displacement of the features from images taken at different times. Against the backdrop of limiting the computing effort the value determined in the image processing method to determine the relative velocity is preferably the maximum value of the correlation function between images taken at different times. The correlation function analysis is distinguished moreover by a high level of robustness with regard to defective measurements.

In the case of the correlation function analysis the quality feature for determining the relative movement between sensor and object surface is preferably the half-width, and/or the signal-noise ratio, and/or the spurious free dynamic range (SFDR) of the correlation signal, wherein in the case of the correlation function analysis under the signal-noise ratio in an analogous manner to the signal-noise ratio determined in the spatial frequency filter method is understood the ratio of the integral over the maximum value of the correlation function to the integral over the remaining characteristic of the curve.

So as to obtain reliable values for the velocity measurement over longer time periods also, even under changing conditions of illumination, in accordance with a further advantageous embodiment of the invention provision is made that the illumination parameters of the light-sensitive elements are regulated. Furthermore provision can be made that the information content of the data read out from the light-sensitive elements (brightness values) is checked and in the event of too low an information content a warning signal is outputted to the user. This can, for example, be the case if the light-sensitive elements are poorly adjusted relative to the object surface to be recorded. If means of illumination are present for the illumination of the object surface, it is moreover possible not only to regulate the light-sensitive elements with regard to their parameters, but also to influence in a regulating manner the means of illumination with regard to their properties (brightness, focusing).

Another aspect of the disclosure provides a sensor for the measurement of a relative velocity of an object surface, which enables precise measurements over a wide range of velocities, in particular even at low velocities, and is distinguished by a comparatively simple circuit architecture that is able to work with components that are available as standard.

The disclosure provides a sensor for the measurement of a velocity of an object surface relative to the sensor, with a plurality of light-sensitive elements arranged spaced apart from one another, and with means of control and evaluation. The means of evaluation are designed such that the signal is generated in accordance with the spatial frequency filter method and in accordance with the image processing method and in that the sensor comprises means for selection of the signal in each case generated in accordance with the spatial frequency filter method and in accordance with the image processing method, the means of selection being designed such that they monitor the frequency signal determined in the spatial frequency filter method with regard to the frequency value determined and/or with regard to at least one quality feature, and in the event that the frequency signal lies below a frequency value to be established and/or the frequency signal does not achieve a quality feature value to be established, to select the value determined in the image processing method for the determination of the relative velocity.

In an analogous manner to the method for measuring a velocity of an object surface relative to a sensor, it is suitable both for the precise measurement of high velocities—here the spatial frequency filter method is used—and also for the measurement of low velocities, or even of an intermittently stationary object. For this measurement the means of selection provided according to the invention select the image processing method, as soon as the frequency value determined in the spatial frequency filter method lies below a frequency value to be established and/or the frequency signal does not achieve at least one quality feature value to be prescribed.

For the sensor, standard electronic circuit components, in particular integrated circuits such as FPGAs or DSPs, can be used. In particular the light-sensitive elements of the sensor take the form of CCD or CMOS components, arrays or lines, photodiodes or phototransistors.

By the use of means of regulation for the regulation of the illumination parameters of the light-sensitive elements it is possible to achieve at each measurement point in time and under all illumination conditions illumination parameters that are always optimal; these are the prerequisite for reliable measurements. Furthermore the sensor according to the invention preferably comprises means for checking the information content of the data read out from the light-sensitive elements, where in the event of too low an information content a warning signal can be outputted to the user.

In some implementations, the sensor is made that the means of control are designed such that the intervals in time for read-outs from the light-sensitive elements can be variably adjusted. This has the advantage that, for example, in the sensor-supported monitoring of very evenly running processes, for example the velocity measurement of very slowly running web-form material, the cycle time, i.e. the interval in time between two measurement processes, can be lengthened. Correspondingly with the velocity measurement in accordance with the image processing method, which according to the invention is used in particular at low velocities, at which the spatial frequency filter method does not deliver satisfactory measurement results, the computing effort can be significantly reduced. By means of lengthened cycle times it is moreover possible to average out transients from the measurements in a suitable manner. Vice versa it is correspondingly true that with comparatively high and strongly fluctuating velocities, in which one must work in particular with measurements of instantaneous values, the cycle time can be shortened.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic view of an exemplary sensor for the measurement of a velocity of an object surface relative to the sensor in a very schematic block diagram, and

FIG. 2 shows a flow diagram of an exemplary arrangement of operations of a method for the measurement of a velocity of an object surface relative to the sensor.

### DETAILED DESCRIPTION

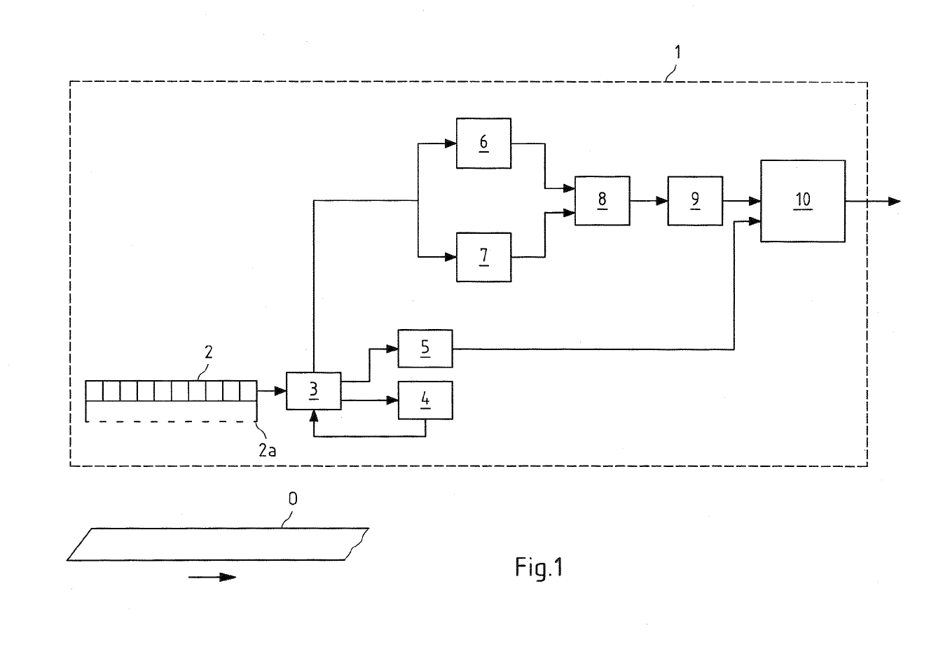

FIG. 1 represents in a very schematic view a sensor 1 for the measurement of a velocity of an object surface relative to the sensor 1. The sensor 1 comprises a plurality of light-sensitive elements 2 arranged spaced apart from one another, for example in the form of a CCD line, optics 2a, which foil an image of the object surface onto the light-sensitive elements 2, and also means of control 3, which read out from the light-sensitive elements 2 of the sensor 1 at intervals of time. The means of control 3 forward the brightness values read out from the light-sensitive elements 2 to means of evaluation 6, 7, which for their part generate in each case a signal proportional to the velocity to be measured.

The means of evaluation 6, 7 are designed such that they generate signals in accordance with spatial frequency filter method SFV and the image processing method BVV.

In detail, the means of evaluation 6 generate in the spatial sequence filter method SFV a frequency value proportional to the velocity to be measured, while the means of evaluation 7 determine the value of the correlation function between two images taken at an interval of time relative to one another, whereby in a manner known per se the displacement of the object surface in the interval of time can be determined, and from this the velocity of the object surface. The respective output signals of the means of evaluation 6, 7, namely the frequency signal of the means of evaluation 6, and the correlation signal of the means of evaluation 7, are forwarded to a means of selection 8.

The means of selection 8 now checks the frequency signal determined in the spatial frequency filter method SFV originating from the means of evaluation 6 with regard to the frequency value determined and/or with regard to at least one quality feature, for example the signal half-width, the signal-noise ratio, and/or the spurious free dynamic range (SFDR), and in the event that the frequency signal lies below the frequency value to be established by the user and/or the frequency signal does not achieve one or a plurality of prescribed values of the quality features previously cited, selects the value determined in the image processing method BVV for the determination of the relative velocity, in the present example, therefore the maximum value of the correlation function.

However, if the frequency value of the frequency signal entered into the means of selection 8 from the means of evaluation, for example, lies above the frequency value to be established by the user, the means of selection 8 selects the frequency signal for the determination of the relative velocity between the object surface and the sensor.

The signal selected in each case is then entered into a means of validation 9, in which a check is made as to whether the signal is reliable, or whether it is based on a measurement that is obviously defective. In the latter case, in place of the unreliable signal, the signal of the last reliable measurement is used, or an average value of the signals of a plurality of lastly obtained reliable measurements, in particular the arithmetic mean or the median. Alternatively, in the case of dynamically moving objects, the signal can be replaced by an extrapolation of the characteristics of the signals of the last reliable measurements.

From the means of validation 9, the signal is then forwarded into an output unit 10, where it can be outputted to the user.

In addition to the previously cited components, the sensor 1 comprises also means of regulation 4, with which the illumination parameters of the light-sensitive elements 2 can be regulated, so that under all conditions of illumination optimal illumination parameters are always present. Moreover, the sensor 1 also comprises means 5 for checking the information content of the data read out from the light-sensitive elements 2. If necessary, these serve to output to the user a warning signal via the output unit 10 if the information content of the data read out from the light-sensitive elements 2 is too low so that no sensible velocity measurement can be undertaken. This can, for example, be the case if the light-sensitive elements 2 are poorly adjusted relative to the object surface to be recorded.

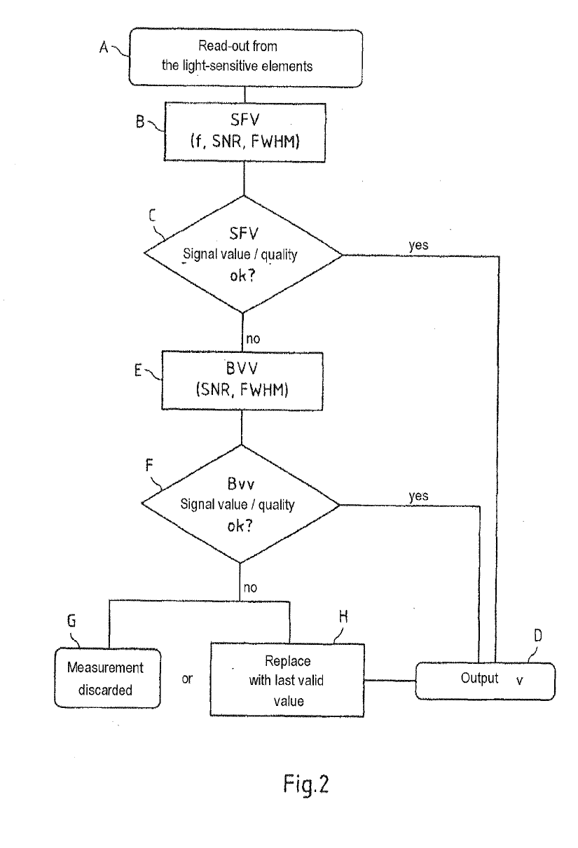

In what follows the method for the measurement of the relative velocity between the object surface O and the sensor 1 is again elucidated with the aid of the flow diagram presented in FIG. 2.

By the means of control 3 the brightness values of the light-sensitive elements 2 are read out at intervals of time and forwarded to the means of evaluation 6, 7 (step A—cf. FIG. 1). In the means of evaluation 6 a frequency signal proportional to the velocity to be measured is generated (step B) on the basis of the spatial frequency filter method SFV, and forwarded to the means of selection 8. There in a step C the frequency signal f is analysed with regard to its signal value and signal quality, for example the signal-noise ratio SNR or the signal half-width FWHM. If the signal value or the signal quality satisfies the criteria prescribed by the user, the measured relative velocity is outputted to the output unit 10 of the sensor 1 (step D). In the other case, the means of selection 8 select the correlation signal determined in parallel to the spatial frequency filter method SFV in the image processing method BVV (step E). This in turn is monitored with regard to its signal value and/or its signal quality and in the event that it satisfies the criteria prescribed by the user, is fed to the output unit 10, where the relative velocity is outputted. In the other case, the measurement is either discarded (step G) or the value is replaced by the last valid value of a previous measurement, whereupon the latter is fed to the output unit 10 (step H).

1-15. (canceled)

16. A method for measuring a velocity of an object surface relative to a sensor, the method comprising:
receiving element signals of the sensor at intervals of time, the sensor having a plurality of light-sensitive elements arranged spaced apart from one another, wherein one or more of the plurality of light-sensitive element outputs an element signal indicative of detected brightness;
producing a frequency signal according to a spatial frequency filter method;
producing a correlation signal according to an image processing method;
monitoring the produced frequency signal regarding at least one of a frequency value and at least one quality feature of the frequency signal; and
selecting a produced signal for determining the velocity of the object surface relative to the sensor, wherein the correlation signal is selected in the event that one or both of the frequency signal value lies below a threshold frequency value and the at least one quality feature fails to achieve a threshold quality feature value.

17. The method of claim 16, wherein the quality feature of the frequency signal comprises at least one of a signal half-width, a signal-noise ratio and a spurious free dynamic range of the frequency signal.

18. The method of claim 16, further comprising discarding a determined relative velocity when the at least one quality feature of the frequency signal fails to achieve the threshold quality feature value.

19. The method of claim 18, further comprising replacing the frequency signal with a last determined valid frequency signal when the at least one quality feature of the frequency signal fails to achieve the threshold quality feature value.

20. The method of claim 18, further comprising replacing the frequency signal with an average of a plurality of last determined valid frequency signals when the frequency signal fails to achieve the threshold quality feature value.

21. The method of claim 20, wherein the average frequency signal comprises an arithmetic mean of the plurality of last determined valid frequency signals.

22. The method of claim 20, wherein the average frequency signal comprises a median of the plurality of last determined valid frequency signals.

23. The method of claim 18, further comprising replacing the frequency signal with an extrapolation of a progression of last determined valid frequency signals when the frequency signal fails to achieve the threshold quality feature value.

24. The method of claim 16, wherein determining the correlation signal according to the image processing method for determining the relative velocity comprises locating features of the object surface and determining a displacement distance of the object surface features from images corresponding to element signals taken at different times.

25. The method of claim 16, wherein the correlation frequency determined in the image processing method for determining the relative velocity comprises a maximum correlation frequency of a correlation function between images corresponding to element signals received at different times.

26. The method of claim 25, wherein the at least one quality feature value comprises at least one of a correlation signal half-width, a signal-noise ratio of the correlation signal, and a spurious free dynamic range of the correlation signal.

27. The method of claim 16, further comprising regulating illumination parameters of the light-sensitive elements.

28. The method of claim 16, further comprising monitoring information content of the element signals and producing a warning signal when the information content is below a threshold information content level.

29. A sensor for measuring a velocity of an object surface relative to the sensor, the sensor comprising:
a plurality of light-sensitive elements arranged spaced apart from one another;
a controller receiving element signals indicative of detected brightness from the light-sensitive elements at intervals of time;
an evaluator producing a signal proportional to the object surface velocity, the evaluator producing a frequency signal according to a spatial frequency filter method and a correlation signal according to an image processing method; and
a selector selecting a produced signal for determining the velocity of the object surface relative to the sensor, the selector monitoring the produced frequency signal with regard to at least one of a frequency value and a quality feature of the frequency signal, the selector selecting the produced correlation signal in the event that at least one of the frequency signal lies below a threshold frequency value and the frequency signal fails to achieve a quality feature value.

30. The sensor of claim 29, wherein the light-sensitive elements comprise at least one of charge-coupled device components, CMOS components, arrays of components, lines of components, photodiodes, and phototransistors.

31. The sensor of claim 29, further comprising a regulator regulating illumination parameters of the light-sensitive elements.

32. The sensor of claim 29, further comprising a monitor monitoring information content of the element signals and producing a warning signal when the information content is below a threshold information content level.

33. The sensor of claim 29, wherein the controller is configured for variably adjusting the time intervals for receiving the element signals from the light-sensitive elements.

34. The sensor of claim 29, wherein the selector discards a determined relative velocity when the frequency signal fails to achieve the threshold quality feature value.

35. The sensor of claim 29, wherein the selector replaces the frequency signal with a last determined valid frequency signal when the frequency signal fails to achieve the threshold quality feature value.

36. A sensor for measuring a velocity of an object surface relative to the sensor, the sensor comprising:
a plurality of light-sensitive elements arranged spaced apart from one another;
a controller receiving element signals indicative of detected brightness from the light-sensitive elements of the sensor at intervals of time;
a means for producing a frequency signal according to a spatial frequency filter method and a correlation signal according to an image processing method; and
a means for selecting a produced signal for determining the velocity of the object surface relative to the sensor, the means for selecting monitoring the produced frequency signal with regard to at least one of a frequency value, and at least one quality feature of the frequency signal, the means for selecting a produced signal selecting the produced correlation signal in the event that at least one of the frequency signal lies below a threshold frequency value and the frequency signal fails to achieve a quality feature value.
